(19) United States
(12) Patent Application Publication
(10) Pub. No.: US 2009/0199842 A1
(43) Pub. Date: Aug. 13, 2009

(54) Smoker conversion kit

(76) Inventor: Frank P. Foster, JR., Itasca, IL (US)

Correspondence Address: Mr. Timothy D. Smith, 5075 Canton Heights Dr., Jackson, MS, 39211, US

(21) Appl. No.: 12/069,135

(22) Filed: Feb. 8, 2008

(51) Int. Cl. A47J 37/06

(52) U.S. Cl. 126/25 R

(57) ABSTRACT

This invention is to be used primarily to convert a traditional charcoal grill into a multifaceted smoker with wet and dry smoking capabilities. Furthermore, novel racks within the invention allow the user to utilize all of the space within the smoker providing for more food cooked over a given time frame. The invention also included a removal tray allowing access to the fuel and liquid pan with only negligible heat loss and no risk of damage to the contents of the smoker or the surface upon which the smoker is placed when removed from the primary heat source.

### CROSS REFERENCES TO RELATED APPLICATIONS

U.S. Patent Documents

| | | | |
|---|---|---|---|
| 4,467,709 | Aug., 1984 | Anstedt | 126/9R |
| 4,512,249 | Apr., 1985 | Mentzel | 126/9R |
| 5,768,977 | Jan., 1998 | Dabbett | 126/9R |
| 5,909,729 | Jan., 1999 | Nowicke, | 126/25R |
| 6,016,797 | Jan., 2000 | Nowicke | 126/25R |

### DESCRIPTION

### Statement Regarding Federally Sponsored Research and Development

Not Applicable

### REFERENCE TO A “SEQUENTIAL LISTING,” A TABLE, OR COMPUTER PROGRAM LISTING APPENDIX SUBMITTED ON A COMPACT DISC

Not Applicable

### BACKGROUND OF THE INVENTION

(1) Technical Field of Invention

The technical field of the invention is aftermarket smoker conversion kits or systems for kettle grill or other charcoal burning grills. The conversion kit could also be sold along with or accompanying grills providing the ability to utilize a typical grill as a deluxe, multi-functional smoker as well.

(2) Description of Prior Art

Throughout the years there have been patented inventions that utilize some sort of apparatus to attempt to convert a kettle grill used for grilling various foods into a smoker, or slow cooker. Some of these inventions have been relatively successful at their intended result, and some have not. The present invention expands upon these inventions to the extent that it eliminates problems not addressed or solved in previous inventions.

At the core of any smoker conversion apparatus is the cylinder that must be placed in between the bottom portion of the grill which houses the fuel, or charcoal, and usually provides a support structure for the grilling rack and the upper portion of the grill which provides a cover for the grill and is utilized primarily to retain heat. This cylinder expands the interior space of the grill providing for an area in which the “smoking” can take place. The inner components of prior inventions lack functionality when compared to the present invention and its ability to utilize the given space. The design of the lower edge of the chamber provides for improved stability over prior art in that it has a flat surface at its lower edge and a downturn of the lip at that edge. The provides for improved safety as well as ease of use. The present invention provides for larger or more expansive grilling and/or smoking and slow-cooking capacities through the use of a novel dome rack system used in conjunction with grilling racks. This is an improvement over the prior art.

### BRIEF SUMMARY OF THE INVENTION

The present invention is an apparatus that consists of multiple components, including but not limited to, a smoker chamber, a dome rack, at least one grill rack, a large tray, a heat resistant pan and a multi-purpose pan support rack.

The smoker chamber is a hollow cylindrical, rectangular or square body comprised of heat tolerant material, such as but not limited to, aluminum or metal. The chamber will be coated in a heat and corrosion resistant paint on both its exterior surface. This smoker chamber will rest on top of the existing grill bottom portion and underneath the top or upper portion of said grill in such a way as to form a seal that prevents the loss of both heat and smoke.

The chamber will have a telemetry port or hole on its side which will also have an accompanying plug or stopper to prevent loss of heat or smoke. This port will allow the user to test both temperature and moisture content within the smoker itself. The port also allows for the insertion of electronic monitoring devices through the sidewall of the chamber. The chamber is further fitted with heat resistant handles on its exterior surface for movement of the chamber, even when in use. On the interior surface of the chamber are corresponding support brackets to accommodate grill racks at different distances from the heat source and smoker pan.

One novel aspect of the smoker conversion kit is the domed grilling rack which allows the user to smoke or slow cook several whole fish, lobsters, whole hams or any number of longer profiled food items. The domed grilling rack rest on support brackets at the top or upper portion of the smoker chamber. It is comprised of two or more horizontal support structures, with the bottom most support structure having a diameter and shape matching the inner diameter and shape of the smoker chamber. Multiple upright or vertical support structures connect the horizontal support structures forming the dome shaped rack. These upright support structures curve in towards the center of the apparatus forming a dome shape. This dome rack extends upward into the interior space provided for within the top of the existing grill.

Multiple meat hooks can be removably attached to the dome shaped rack allowing meats to hang vertically within the smoker chamber. If the grill racks are removed from the grill or within the smoker chamber itself, large pieces of meat as long as two feet can be hung within the apparatus.

For moist smoking processes, a pan is necessary to be used in conjunction with the fuel or heat source. This invention provides for use of a heat resistant pan of sufficient size to accommodate several quarts of liquid. The pan has a lip extending outward about its upper peripheral edge.

The pan is placed upon or within the pan support rack, which can serve multiple functions in the smoking and grilling areas of use. The pan support rack, like the dome rack, has a plurality of horizontal support structures with the bottom most support structure having a greater diameter than the upper most horizontal support structure. Accompanying vertical support structures tie the pan rack together and bend inward. The upper most horizontal support structure corresponds to the diameter and circumference of the lip of the pan itself. As a result, the pan rests within the pan support rack. The pan support rack gives sufficient vertical clearance when used in conjunction with the pan itself for fuel sources and/or smoker chips to be added below the pan without interference with the effectiveness of the grill or smoker.

Furthermore, the pan support can be rotated onto its vertical or upper surface to accommodate the pan providing the user with the option to wet grill meat or other items without the use of the smoker chamber.

The smoker conversion kit also comes with a large flat tray that is utilized in removing the entire apparatus while the user adds fuel or liquid to the lower half of the grill. This tray is comprised of heat resistant material and has attached to it, heat resistant handles. The user can leave the lid on the smoker chamber and use the smoker chamber's exterior handles to place said chamber and lid onto the tray as opposed to a surface in which the chamber could collect dirt or a surface in which the contents of the smoker could damage due to dripping or heat. Another added benefit of the tray is that the contents continue to cook as heat is not lost through the bottom of the chamber when in contact with the tray.

Moreover, the tray can be fitted with folding legs so as to stand alone eliminating the need to place the tray on another surface such as a counter-top or the ground.

The novel aspects of the invention include the domed rack, the pan rack and the use of the other aspects of the invention in conjunction with these racks to form a smoker conversion different and novel in view of prior art. Furthermore, there are added safety benefits with the use of this invention over prior art due to the connective nature of the surface, the apparatus can be placed on a grill without the use of clips or flanges.

### BRIEF DESCRIPTION OF SEVERAL VIEWS OF THE DRAWINGS

FIG. 1. illustrates the invention is use in conjunction with an existing grill with the smoker chamber visible.

FIG. 2. illustrates the invention from a side profile with elements of the invention in view.

FIG. 3. illustrates a majority of the components of the invention.

FIG. 4. Illustrates the side profile of the invention allowing viewing within the invention itself.

FIG. 5. Illustrates the invention as viewed from the top.

FIG. 6. Illustrates another view from the top with more grill space added in addition to that disclosed before.

FIG. 7. Illustrates the tray aspect of the invention with the legs folded into a locked position not in use.

FIG. 8. Illustrates the tray aspect of the invention with the legs extended for use.

FIG. 9. Illustrates the invention with the conversion components in full view.

### DETAILED DESCRIPTION OF THE INVENTION

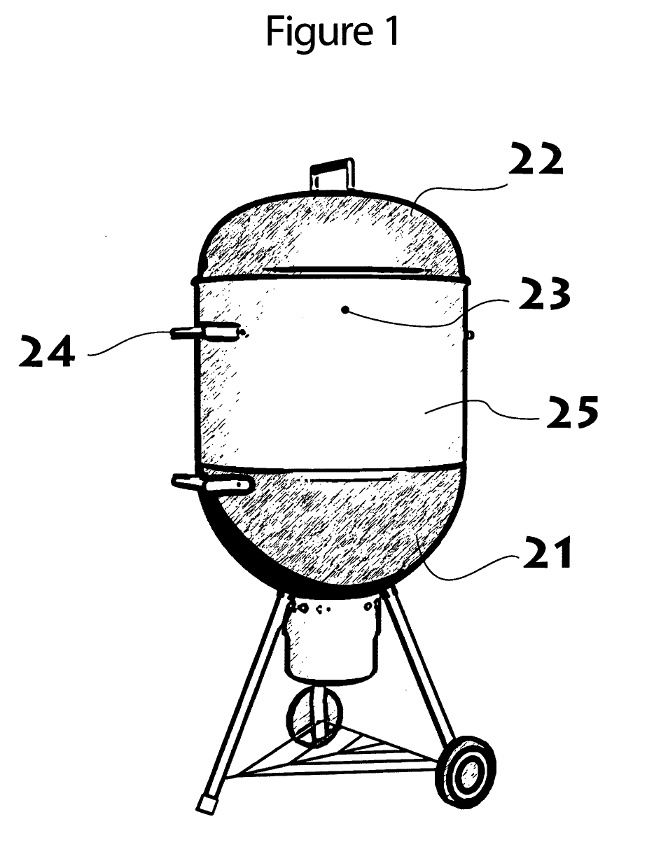

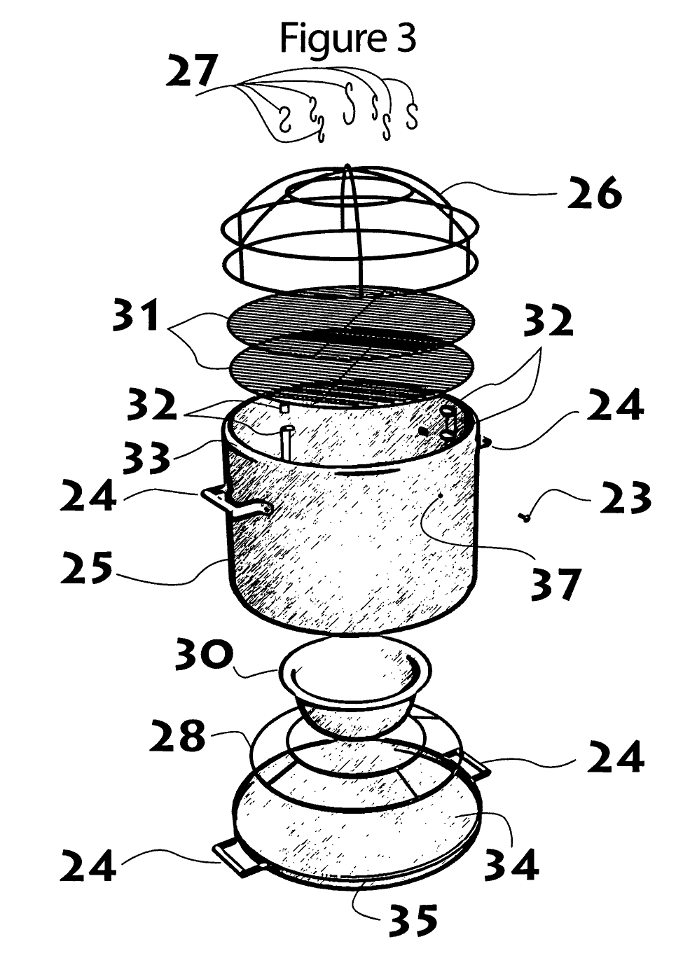

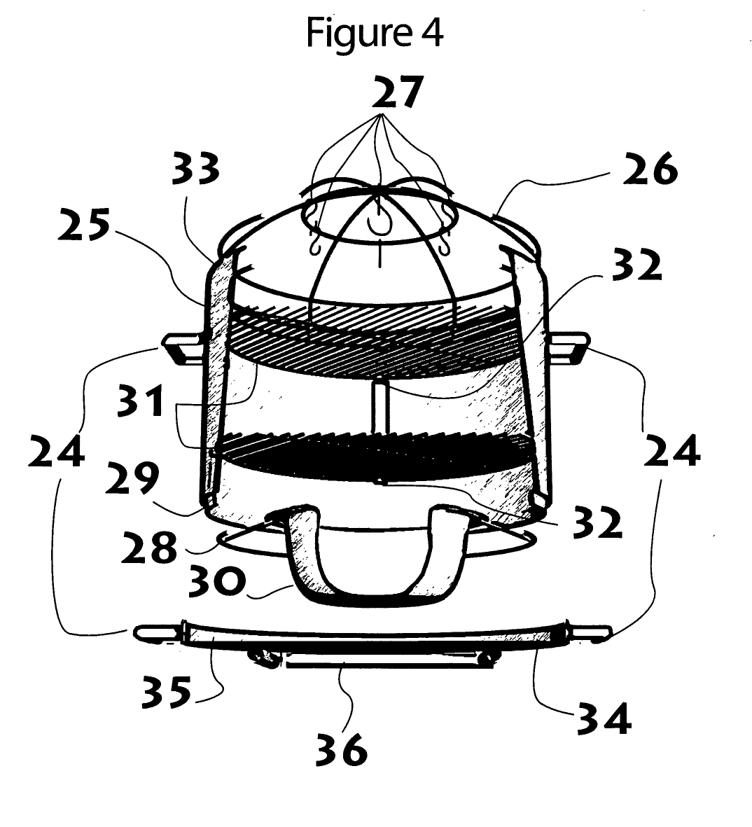

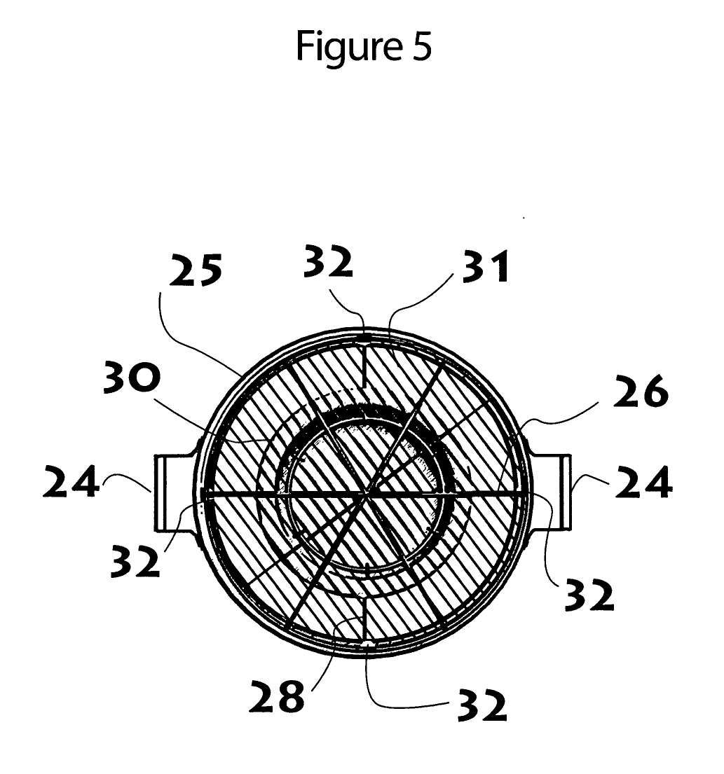

Referring to FIG. 1 through FIG. 9, the invention in comprised primarily of a smoker chamber (25), a dome rack (26), at least one grill rack (31), a large tray (34), a heat resistant pan (30) and a multi-purpose pan support rack (28).

Referring to FIG. 1 through FIG. 5 and FIG. 9, the smoker chamber (25) is constructed to a specific size so as to allow conversion of an existing grill or grill template into a smoker. As such, the size and shape of the chamber (25) can vary depending on the needs of the user and the grill in which the user has access. The smoker chamber (25) will have an upper and lower lip (29) around its top and bottom peripheral edges to provide for a proper seal when used in conjunction with an existing grill. Ideally, the upper lip (29) will rest just inside the bottom portion of the lid (22) of the existing grill. Likewise, the lower lip (29) will securely fit inside or within the bottom portion (21) of the existing grill. The seal formed at the top and bottom should be of such a nature that heat and smoke will not easily escape when the grill and smoker conversion kit are in use. On the chamber's (25) exterior surface are at least two heat resistant handles (24) spaced on opposite sides of the chamber (25) so as to allow balanced movement of the chamber (25) and its components. The chamber (25) should be comprised of a heat tolerant material such as metal and should be coated in a heat resistant paint on its interior and exterior surfaces. The chamber (25) also has a telemetry port (23) which allows the user to test temperature and moisture content within the smoker when in use. The port (23) has an accompanying plug or stopper so no heat, smoke, or moisture is lost when the port (23) is not being used. Further, the chamber has corresponding support brackets (32) around its interior surface to accommodate grill racks (31) at different levels within the chamber (25).

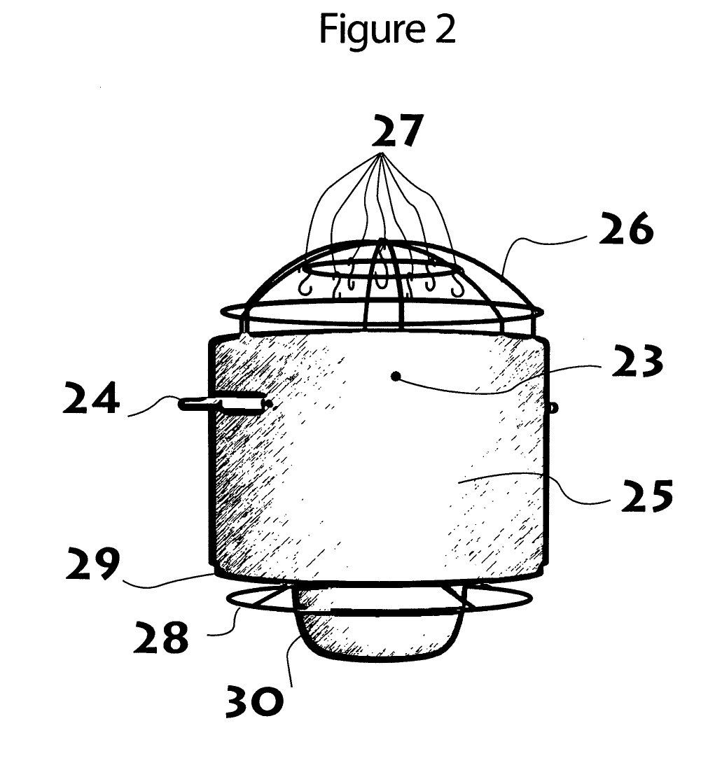

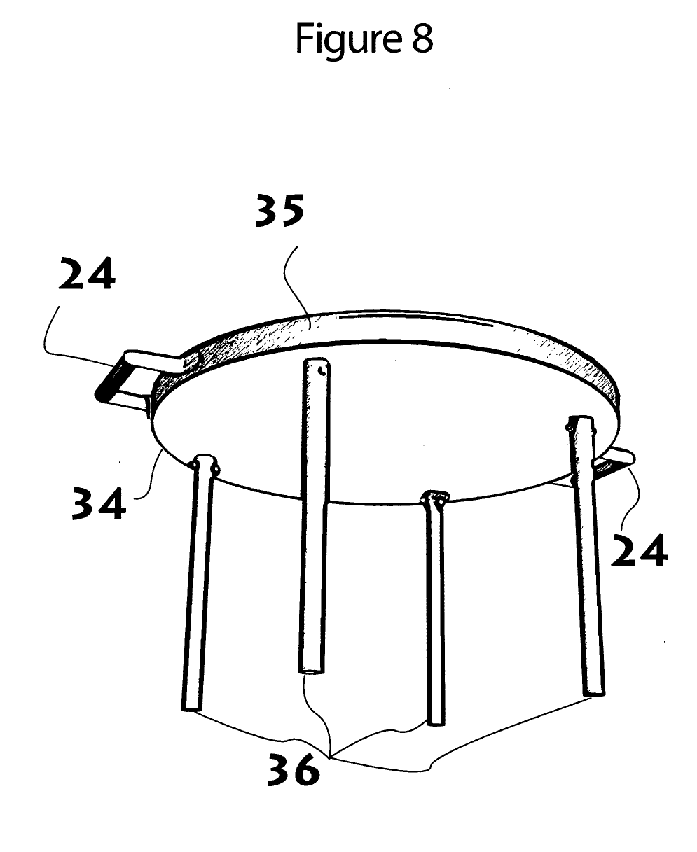

Referring to FIGS. 2, 3 and 4 as well as FIG. 8, the interior aspects of the invention are the dome rack (26) with accompanying meat hooks (27), the pan (30) with accompanying pan rack (28), the grill rack or racks (31) which rest on the support brackets (32) attached to the interior surface of the chamber (25). The dome rack (26) is a very novel aspect of the invention in that it provides for use in cooking or smoking large pieces of food within a relatively small space. The dome rack (26) is comprised of horizontal and vertical support structures, with the vertical structures bending inward forming a “dome” shape. The lowermost horizontal support structure rests on support brackets (32) within the chamber (25). The dome rack (26) should be comprised of a heat tolerant material such as steel or metal. Meat hooks (27) can be attached to the vertical support structures and large pieces of meat, or other food, can be hung vertically within the chamber (25). The meat hooks are removably attached to the dome rack (26) and utilize gravity and the weight of the food attached thereto to secure the hooks (27) in place. The hooks (27), like the rest of the invention, should be comprised of a heat tolerant to heat resistant material.

Referring to FIG. 2 through 4 and FIG. 8, the invention utilizes a liquid pan (30) that has a lip around its peripheral edge. This pan (30) is used to hold liquid and/or wood chips for smoking the contents of the smoker and can also be utilized in wet grilling applications with the chamber (25) is not in use. The pan (30) is held in place by a pan rack (28), which like the dome rack (26), has horizontal and vertical support structures. The pan (30) and pan rack (28) will rest inside the existing bottom portion (21) of the grill. The upper most horizontal support structure is approximately the diameter of the lip around the pan (30), allowing the pan (30) to rest inside the pan rack (28). The pan rack (28) gives sufficient vertical clearance over the heat source so as not to disturb or impede said heat source. The pan (30) should be comprised of a heat tolerant substance that has the ability to transfer heat to its contents without a breakdown of the material comprising the pan (30) itself due to direct contact with the heat source. Likewise, the pan rack (28) should be comprised of a heat tolerant material which is also very sturdy, such as metal or steel.

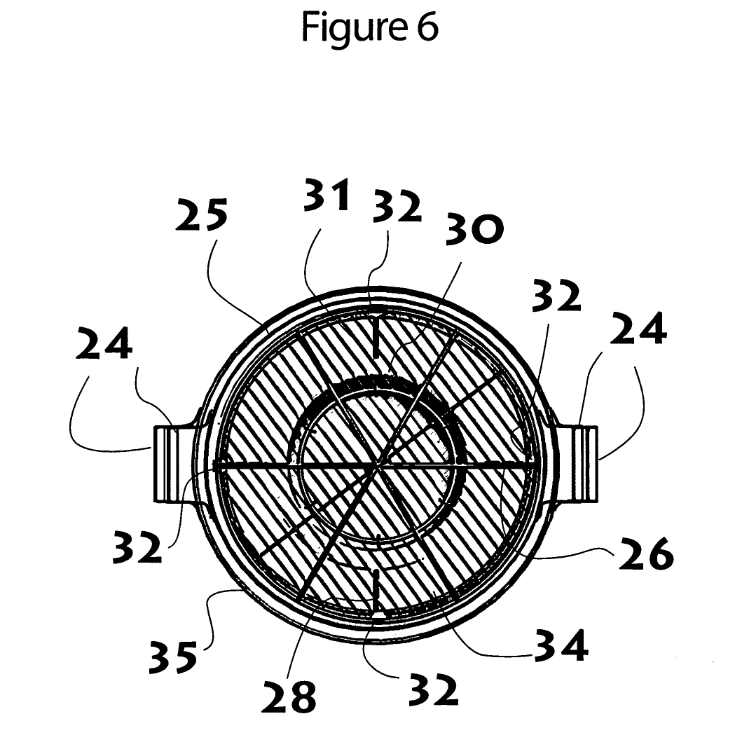

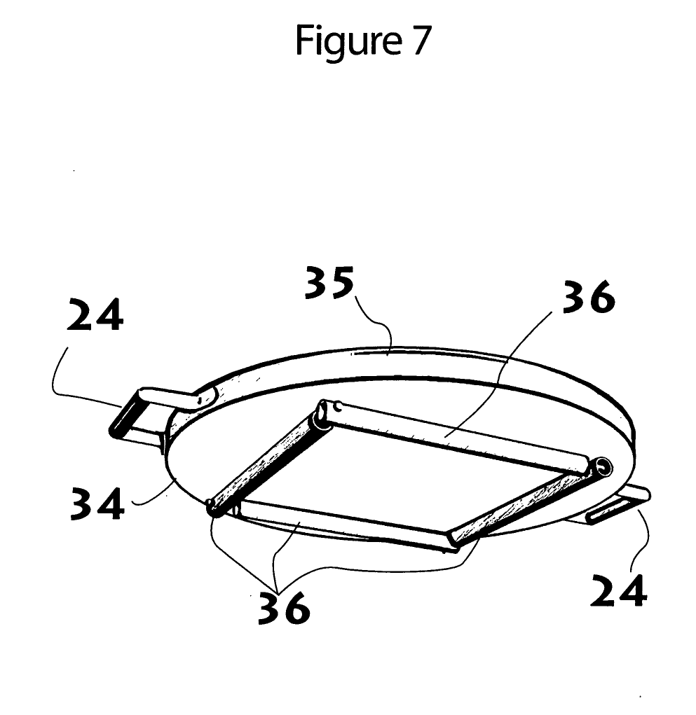

Referring to FIGS. 6 and 7 in particular, another aspect of the invention that can be used in conjunction with the removal of the chamber (25) is the tray (34). The tray (34) is comprised of heat tolerant material. It has corresponding handles (24) and a lip (35) about its peripheral edge to prevent contents within the smoker from soiling the surfaces upon which the tray is placed. A unique feature to the tray is that it has attached to its bottom surface folding legs (36) which allows the user the option to have said tray (34) elevated or not elevated. The tray (34) should be of sufficient size to accommodate the placement of the chamber (25) within the vertical lip (35) of said tray (34).

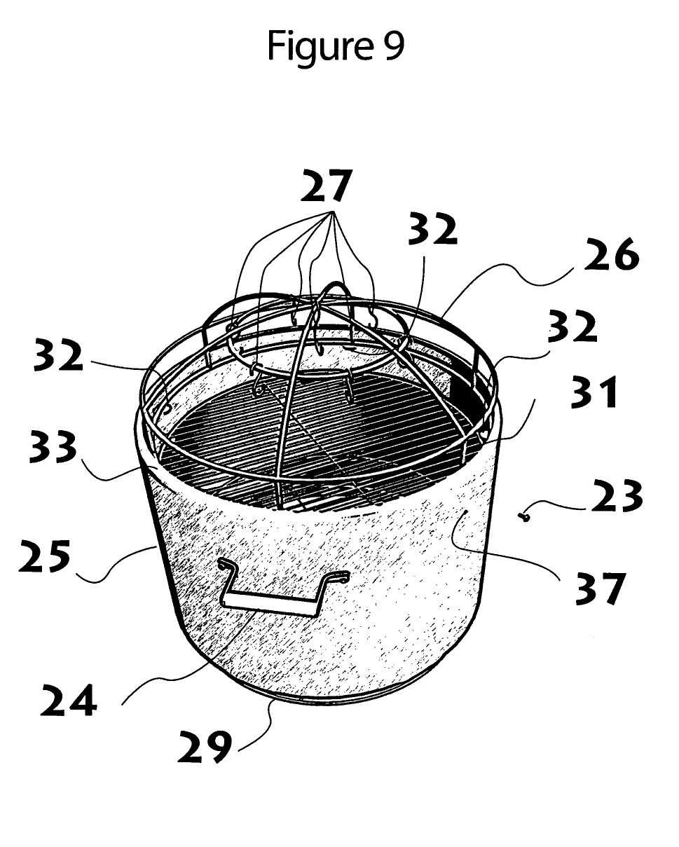

Referring to FIG. 1 and FIG. 9, if the user desires to convert his grill to a smoker utilizing this invention, the user should first remove the top or lid (22) from the existing grill. The user will then remove the grill rack (31) that comes standard with the grill. The fuel or heat source will then be placed within the bottom portion (21) of the existing grill. The pan rack (28) and pan (30) will then be placed over the heat source. The user can place the desire liquid and/or aromatic solid within the pan. The user can, if desired, place the removed grill rack (31) back in place. The smoker chamber (25) will then be placed on top of the bottom portion of the grill (21). If the user desires, grill racks (31) can be placed onto support brackets (32) within the chamber (25) and food placed on the racks (31). The dome rack (26) is then placed on the upper most support brackets (32) within the chamber (25) and meat, or other foods, can be hung from the dome rack (26) by the meat hooks (27). The top portion or lid (22) of the existing grill is then placed upon the upper lip (29) of the chamber (25). The invention is now in place and ready to be used. The chamber (25) can be removed and placed on the tray (34) for removal of food within the chamber (25), or for addition of contents to the pan (30) and adjustment of the heat source.

### DRAWINGS

The drawings referenced in this application are attached hereto.

I claim:

1. A smoker conversion apparatus consisting of:
an upright smoker chamber having an open top and bottom;
the chamber being fitted with corresponding support brackets around its interior surface and heat resistant handles on its exterior surface;
the chamber being able to position in a sealable fashion between the bottom portion of an existing grill and the grill lid or top portion of an existing grill;
a dome rack having horizontal support structures attached in a fixed manner to vertical support structures;
the top horizontal support structure being smaller in diameter than the other horizontal support structures;
the vertical support structures being contoured to attach to the horizontal support structures of varying diameters and being further contoured to conform to the shape of the existing grill lid or top portion;
one or more grill racks of corresponding size and shape to the existing grill;
a large tray of corresponding size and shape to the chamber;
a heat resistant pan having a lip around its upper peripheral edge;
a pan support rack having horizontal and vertical support structures with the top horizontal support structure being smaller in diameter than the bottom support structure;
the top horizontal support being of a corresponding diameter to the pan to hold the pan in place in a secure fashion when the pan is place on the pan support rack;
multiple meat hooks removable attached to the top horizontal support structure of the dome rack;
a tray with folding legs to accommodate the apparatus when removed from the existing grill; and
a telemetry port with an accompanying plug or stopper in the side of the smoker chamber.

2. The apparatus as in claim 1, further wherein:
the chamber being cylindrical in shape.

3. The apparatus as in claim 1, further wherein:
the chamber being rectangular in shape.

4. The apparatus as in claim 1, further wherein:
the chamber being square in shape.

5. The apparatus as in claim 1, further wherein:
the dome rack and the pan support rack correspond in shape to the chamber.

6. The apparatus as in claim 1, further wherein:
the dome rack and the pan support rack are comprised of a heat resistant substance that is tubular in structure.

7. The apparatus as in claim 1, further wherein:
the chamber is coated in a heat resistant paint or finish.

8. The apparatus as in claim 1, further wherein:
the pan support is of sufficient vertical clearance within the framework of the pan support to accommodate fuel and smoker chips.

9. The apparatus as in claim 1, further wherein:
the pan support can be rotated onto its upper surface and utilized in conjunction with the heat resistant pan in moist grilling applications.
